(19) United States
(12) Patent Application Publication
(10) Pub. No.: US 2011/0022668 A1
(43) Pub. Date: Jan. 27, 2011

(54) ELECTRONIC TICKETING SYSTEM AND APPLICATION METHOD THEREOF

(75) Inventors: Shu-Fen Shih, Hsinchu County (TW); An-Jye Huang, Hsinchu City (TW)

Correspondence Address: WPAT, PC;INTELLECTUAL PROPERTY ATTORNEYS, 7225 BEVERLY ST., ANNANDALE, VA, 22003, US

(73) Assignee: ACCTON TECHNOLOGY CORPORATION, Hsinchu (TW)

(21) Appl. No.: 12/766,386

(22) Filed: Apr. 23, 2010

(30) Foreign Application Priority Data
Jul. 22, 2009 (TW) 098124670

(51) Int. Cl. G06F 15/16

(52) U.S. Cl. 709/206

(57) ABSTRACT

A user can book a ticket in advance and after that by means of wireless or/and wire-line transmission a service center replies an acknowledge message which contains a first Internet address to a user-designated portable hand-held device. While the user clicks the web site/address, a corresponding ticket appears or an identification signal appears for identification. After the web site being clicked, the content appeared on the web site is being transferred to a second web site, and while the same application or booking procedure is done again, the first Internet address stored in the electronic ticketing system and a second Internet address will be compared. By means of web site exchanging, the web site being transmitted to the user-designated portable apparatus are non-identical, hence, the tedious process of logging/encryption/decryption can be evitable and improper duplicate utilization of the electronic tickets can be saved.

### BACKGROUND OF THE INVENTION

1. Field of the Invention

The present invention relates to an electronic ticketing system and an application method thereof, and more particularly, to an electronic ticketing system for practicing secrecy by transmitting various web sites and an application method thereof.

2. Description of the Prior Arts

During the conventional electronic ticketing servicing, most of the time, IC (integrated circuit) cards are used, and the cards can be categorized into contact type or contactless type. For example, the former can be debit cards, credit cards . . . etc, and the latter can be Taipei easy card for metro, buses and parking service. However, either in usage of the contact-typed or contactless cards, their applications will be limited by the expiry date or location restriction. Meanwhile, while one single user possesses a plurality of cards, the issue of compatibilities and installation costs arises, thus consequently resulting in worst economic performance.

U.S. Pat. No. 6,002,771 discloses a method and system for regulating discounts on merchandise distributed through networked computer systems. The method and system discloses a mechanism of confirming the validity of electronic coupons by means of a plurality of encryptions and decryptions upon the electronic coupon. However, the process of duplicate encryptions/decryptions increases the complexity and overload of operating the electronic coupon system, and the decrypted electronic coupon can be repeatedly used. Alternatively, duplicating the electronic coupons may also cause providers of providing electronic coupon service to difficultly calculate the actual number such that the amount of electronic coupons which is utilized and circulated to the outside does not match the initial issuing of number, and the coupons lack good secrecy.

Accordingly, in view of the above drawbacks, it is an imperative that an electronic ticketing applicable to the system and application method of certificates or identifications or valued coupons (currency exchangeable), particularly applicable to the electronic ticketing systems and application method by changing web sites for practicing secrecy and counting actual usage is designed so as to solve the foregoing drawbacks.

### SUMMARY OF THE INVENTION

In view of the disadvantages of the prior art, the primary object of the invention is to offer a mechanism for the user to book a reservation on discounted merchandises and/or services provided by merchants from a ticketing service center in advance through telephone speech, Internet or other means. After completing the booking, the ticketing service center can reply to a message having a web site with one or more random numbers in wired or wireless transmissions by way of a short message and a multimedia message and transmit the message to a user-designated apparatus such as a portable Internet handheld apparatus. More general, the present invention relates to an electronic ticketing system for practicing secrecy by transmitting various web sites and an application method thereof.

According to one aspect of the present invention, the present invention relates to an electronic ticketing system for practicing secrecy by means of transmitting various web sites, comprises: a transaction processing server, for issuing an electronic ticket and recording the usage of the electronic ticket; a system server, for transmitting a short message or an email having an web site to a portable Internet handheld device and notifying the transaction processing server in necessary; a memory, for storing the short message and the web sites stored in the short message; a comparator, for comparing a newly added web site with the web sites stored in the memory; and a random number generator, for generating one or more random numbers that is taken as a part of the newly added web site.

According to another aspect of the present invention, the present invention relates to an electronic ticketing method for practicing secrecy by means of transmitting various web sites, comprising steps of: (a) transmitting an electronic message having a first web site from a system server to a portable Internet handheld device; (b) transmitting an acknowledge signal from the portable Internet handheld device to the system server, if the first web site shown at the portable Internet handheld device is clicked; (c) recording an issued electronic ticket by the system server or informing a transaction processing server to issue an electronic ticket, and transmitting the electronic ticket to the system server; (d) uploading the electronic ticket upon an web-page specified by the first web site (e) removing the electronic ticket from the first web site; (f) randomly generating a second web site; and (g) comparing the second web site with all web sites, which are currently used, or recorded by the system server, if the second web site is identical to one of the web sites recorded by the system server, go to step (f), if not identical, go to step (a) and meanwhile updating the first web site as the second web site.

According to another aspect of the present invention, the present invention relates to a method for transmitting an electronic ticket corresponding to a user-designated area by means of a networking computer system, comprises steps of: (a) providing a portable Internet handheld device which can be plugged to the networking computer system; (b) accessing a ticket service center by the portable Internet handheld device via a worldwide web which is applicable to the networking computer system(c) inputting an area identification code to the ticket service center; and (d) transmitting by the ticket service center correlated ticketing information corresponding to the area identification code via a short message or an e-mail to the portable Internet handheld device.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become readily understood from the detailed description given herein below and the accompanying drawings which are given by way of illustration only, and thus are not limitative of the present invention and wherein:

FIG. 1 relates to one of preferred embodiments according to the electronic ticketing system of the present invention;

FIG. 2 relates to a flow chart according to the electronic ticketing system of the present invention; and

FIG. 3 relates to another flow chart according to the electronic ticketing system of the present invention.

### DESCRIPTION OF THE EXEMPLARY EMBODIMENTS

The following descriptions are of exemplary embodiments only, and are not intended to limit the scope, applicability, or configuration of the invention in any way. Rather, the following description provides a convenient illustration for implementing exemplary embodiments of the invention. Various changes to the described embodiments may be made in the function and arrangement of the elements described. For your esteemed members of reviewing committee to further understand and recognize the fulfilled functions and structural characteristics of the invention, several exemplary embodiments cooperating with detailed description are presented as the follows.

According to one embodiment of present invention, an electronic ticketing system provided by the inventor is adopted in various electronic fields, such as mobile pass, mobile key, mobile transaction, movie ticket, coupon, gift ticket, VIP card, and membership card. A user can apply for a ticket in advance or make a reservation via phone calling, internet network or other ways by the electronic ticketing system. The ticketing service center can reply an acknowledge message, for example, a short text messages or a multimedia message, to the user by wire/wireless transmission after the application or the reservation is done. Specifically, the acknowledge message can be transmitted from a system server to one of the user designated apparatus, such as a portable Internet handheld device. And the acknowledge message comprises a first web site which comprises one or more random numbers, such as: http://www.accton.com./yuso520999. While the user clicks the first web site, a corresponding ticket then is shown on a web page corresponding to the web site to facilitate the application. Thus, a plurality of tickets can be altered and used in a single machine so as to prevent a plural of tickets and ID from being carried by the user, and the correlated vendors can save the related human resource expenses by simplifying the fee collecting procedure. After first web site: http://www.accton.com./yuso520999 is clicked, an identifying symbol, for example, a two-dimensional code, is generated and shown for identifying the first web site http://www.accton.com/yuso520999. The identifying symbol is selected from a group of mobile pass, mobile key, mobile transaction, movie ticket, coupon, gift ticket, VIP card, member card, and the like. The content of the two-dimensional code is transferred to a second web site, such as http://www.accton.com/patent168888 after the two-dimensional code is shown for a while.

While the same application or reservation procedure is executed or the same user repeatedly applies the same application or reservation, a newly added web site and the web sites originally stored in the memory of the electronic ticketing system will be compared; the purpose for comparing the first web site with the second web site is, by means of exchanging web sites, to ensure that the web sites, which are outputted from the server, transmitted to the portable Internet handheld device that is designated by the ticket buyer are different for each time of usage. Since only the ticket buyer's designated apparatus will receive a message including the information of the second web site, thus no stranger or the third party can access the second web site. At this time, the ticket buyer needs to click the second web site such that the server receive the signal so as to show a distinguish content on the web-page of the second web site, such as a two-dimensional code, hence, the tedious process of logging/encryption/decryption can be evitable, and improper duplicate usages of the electronic tickets can be saved. For every single user, each time of change of the web sites, namely, for each of the path for which the website's Internet resource store at, its change refers to each time of usage that can be recorded by a transaction processing server, and being transmitted back to the user as a reference of payment or discount.

In one of the preferred embodiment in the present invention, the information database of the ticket service center such as the transaction-processing server can be used to further categorize and record the various industry vendors, which provide merchandises or services, such as food, liquor, cosmetics, sports, or where the vendor located. For example, via the categorization of the zip code, the electronic tickets of merchandises/services provided by vendors located within the area of the same zip code such as discount coupons or member cards can be correspondingly outputted to the portable Internet handheld apparatus for which the user carries to serve the purpose of consuming in the above vendors, thus, the option range can be increased and the high cost for searching the stores providing locations of the electronic tickets via GPS can be avoided. For example, if desired to traveling to Keelung for shopping, then the portable Internet handheld device is connected with a media apparatus having an USB interface (such as a computer, a router, AP and the like) via Internet so as to access various categorizations provided by, for example, the ticket service center, such as the area identification code to choose the zip code corresponding to Keelung, and information of discounted merchandise/service/member sale correlated to Keelung area was passed to the apparatus. Yet the zip code is one of the categorizations and not limited thereto.

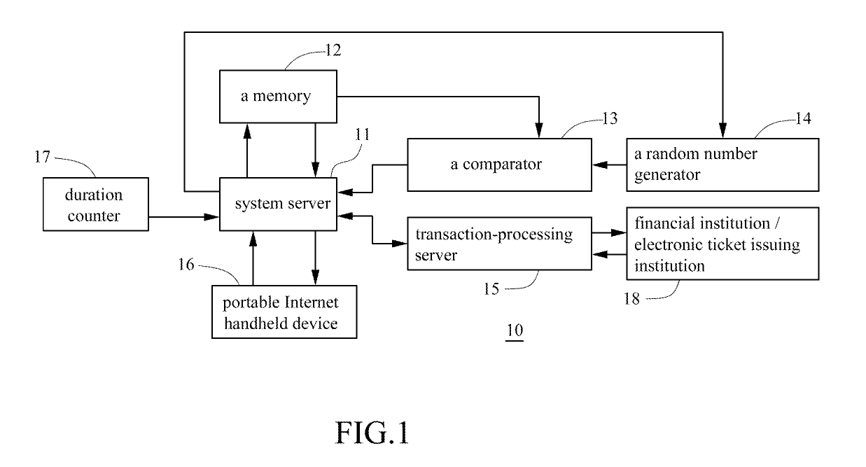

Please refer to FIG. 1, which relates to one of the preferred embodiments of the electronic ticketing system 10 of the present invention. The electronic ticketing system 10 comprises: a system server 11, a memory 12, a comparator 13, a random number generator 14 and a transaction-processing server 15. Wherein, the system server 11 is for transmitting a short message or an email having a web site to a portable Internet handheld device 16, and said server 11 notifies the transaction processing server 15 while the user clicks the website of said short message so as to issue an electronic ticket which can be a two-dimensional bar code. The memory 12, coupled to the system server 11, is for keeping track of the short message for being transmitted to the user and the website stored inside the short message. The comparator 13, for comparing a newly added web site such as http://www.accton.com/yuso520999 and one of the website originally stored in the memory 12 such as http://www.accton.com/patent168888, outputs the compared result to the system server 11 and the memory 12 if the two websites are not completely identical. The random number generator 14, for generating a random number to be a part of the web site (http//www.accton.com), preferably, appends a random number at the end of the known website. For example, the random numbers can be either yuso520999 or patent168888 which can be appended at the end of http/www.accton.com for facilitate the system server 11 outputs a short message or an email comprising http://www.accton.com/patent16888 to the user designated apparatus. After the web site, received by the portable Internet handheld apparatus 16 contained in the short message or e-mail being clicked, the apparatus 16 transmits an acknowledge signal to the system server 11, at the same time, the system server 11 notifies the transaction processing server 15, hence, the web-page corresponding the website of the clicked short message or e-mail shows up a two-dimensional bar code so as for facilitate the user to complete reading for the electronic ticket.

Preferably, the electronic ticketing system 10 further comprises a duration counter 17, counts a specific duration for uploading the electronic ticket and holding the electronic ticket on the web site.

As aforementioned, preferably, the random number generator 14 can randomly generate a web site, and the website can contain a known information such as www.accton.com and a random number such as yuso520999.

Preferably, the transaction-processing server 15 further comprises a sequence counter, counts the sequence for which the electronic ticket is accessed so as to inform a financial institution or an electronic ticket issuing institution 18. Meanwhile, the server 15 can further comprise a database, for storing a categorization categorized by zip code.

Preferably, the portable Internet handheld device is a 3G (third-generation) cellular phone or a WiMAX (Worldwide Interoperability for Microwave Access) modem.

Preferably, the electronic ticket is selected from the group of mobile pass, mobile key, mobile transaction, movie ticket, coupon, gift ticket, VIP card, and member card.

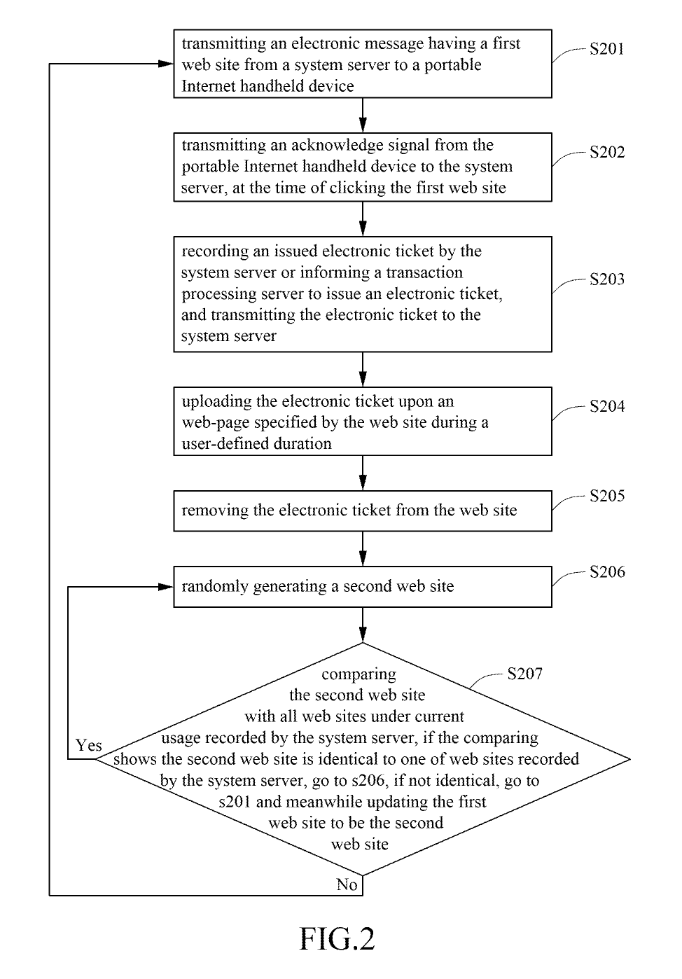

Please refer to FIG. 2, which relates to an electronic ticketing method for practicing secrecy by means of transmitting various web sites, comprising steps of: s201: transmitting an electronic message having a first web site from a system server to a portable Internet handheld device; s202: transmitting an acknowledge signal from the portable Internet handheld device to the system server, if the first web site shown at the portable Internet handheld device is clicked; s203: recording an issued electronic ticket by the system server or informing a transaction processing server to issue an electronic ticket, and transmitting the electronic ticket to the system server; s204: uploading the electronic ticket upon an web-page specified by the first web site; s205: removing the electronic ticket from the first web site; s206: randomly generating a second web site; and s207: comparing the second web site with all web sites, which are currently used, or recorded by the system server, if the second web site is identical to one of the web sites recorded by the system server, go to s206, if not identical, go to s201 and meanwhile updating the first web site as the second web site.

Preferably, the website can also be http://www.accton.com/yuso520999, where www.accton.com is known (off-the-shelf) information for the user as serving the identification purpose, and also a plurality of random number such as yuso520999.

Preferably, the electronic message is a short message or an e-mail.

Preferably, the electronic ticket is selected from the group of mobile pass, mobile key, mobile transaction, movie ticket, coupon, gift ticket, VIP card, and member card.

Preferably, the method further accords a categorization, such as zip code and the like, further comprises a step of: correspondingly outputting electronic tickets, upon a categorization such as a zip code, provided by the vendors located around an area of the zip code.

Preferably, the user-defined duration is the applicable period allowing the user to read the uploaded electronic ticket.

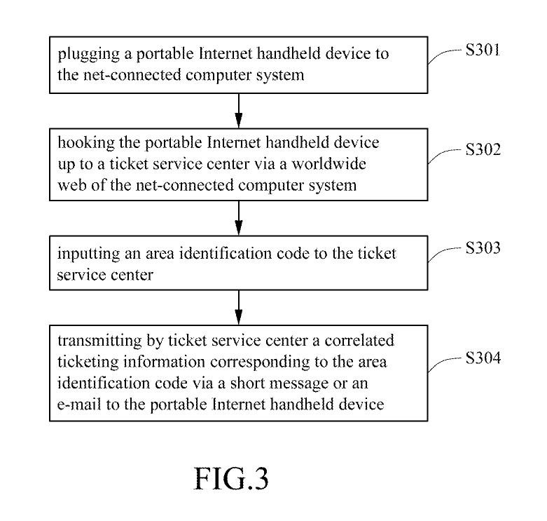

Please refer to FIG. 3, which further illustrate a method for transmitting an electronic ticket of a user-designated area by means of a networking computer system, comprises steps of: s301: providing a portable Internet handheld device to the networking computer system; s302: accessing a ticket service center by the portable Internet handheld device via a worldwide web which is applicable to the networking computer system; s303: inputting an area identification code to the ticket service center; and s304: transmitting by the ticket service center a correlated ticketing information corresponding to the area identification code via a short message or an e-mail to the portable Internet handheld device.

Preferably, the area identification code is a zip code.

Preferably, the portable Internet handheld device has a USB interface.

Preferably, the aforementioned ticketing information is displayed on a web page.

Preferably, the web page corresponds to a web site which has a plurality of random numbers generated by a random number generator.

The invention being thus aforesaid, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. An electronic ticketing system for practicing secrecy by means of transmitting various web sites, comprising:
a transaction-processing server, for issuing an electronic ticket and recording usage processes of the “electronic ticket”
a system server, for transmitting a short message or an email having an web site to a portable Internet handheld device and notifying the transaction-processing server in necessary;
a memory, for storing the short message and the web sites stored in the short message;
a comparator, for comparing a newly added web site with the Internet stored in the memory; and
a random number generator, for generating one or more random numbers that is taken as a part of the newly added web site.

2. The electronic ticketing system as recited in claim 1, further comprising: a duration counter for counting a specific duration for uploading the electronic ticket and holding the electronic ticket on the web site.

3. The electronic ticketing system as recited in claim 1, wherein the electronic ticket is selected from the group of mobile pass, mobile key, mobile transaction, movie ticket, coupon, gift ticket, VIP[definition] card, and member card.

4. The electronic ticketing system as recited in claim 1, wherein the portable Internet handheld device is selected from 3G cellular phone and WiMAX [definition], worldwide interoperability for microwave access modem.

5. The electronic ticketing system as recited in claim 1, wherein the transaction processing server further comprises a sequence counter, for counting the sequence for which the electronic ticket is accessed so as to inform a financial institution or an electronic ticket issuing institution.

6. The electronic ticketing system as recited in claim 1, wherein the transaction-processing server further comprises a database, for storing a categorization with zip code information.

7. An electronic ticketing method for practicing secrecy by means of transmitting various web sites, comprising steps of:
(a) transmitting an electronic message having a first web site from a system server to a portable Internet handheld device;
(b) transmitting an acknowledge signal from the portable Internet handheld device to the system server, if the first web site shown at the portable Internet handheld device is clicked;
(c) recording an issued electronic ticket by the system server or informing a transaction processing server to issue an electronic ticket, and transmitting the electronic ticket back to the system server;
(d) uploading the electronic ticket upon an web-page specified by the first web site;
(e) removing the electronic ticket from the first web site;
(f) randomly generating a second web site; and
(g) comparing the second web site with all web sites, which are currently used, or recorded by the system server, if the second web site is identical to one of the web sites recorded by the system server, go to step (f), if not, go to step (a) and meanwhile updating the first web site as the second web site.

8. The electronic ticketing method as recited in claim 7, wherein the web site further comprises a known information or identifier to serve the purpose of user identification.

9. The electronic ticketing method as recited in claim 7, wherein the web site further comprises a plurality of random numbers.

10. The electronic ticketing method as recited in claim 7, wherein the electronic ticket is selected from the group of mobile pass, mobile key, mobile transaction, movie ticket, coupon, gift ticket, VIP card, and member card.

11. The electronic ticketing method as recited in claim 7, wherein the electronic message is a short message or an email.

12. The electronic ticketing method as recited in claim 7, further comprises a step of: correspondingly outputting electronic tickets, upon a categorization such as a zip code, provided by the vendors located around an area of the zip code.

13. A method for transmitting an electronic ticket corresponding to a user-designated area by means of a networking computer system, comprises steps of:
(a) providing a portable Internet handheld device which can be plugged into the networking computer system;
(b) accessing a ticket service center by the portable Internet handheld device via a worldwide web which is applicable to the networking computer system;
(c) inputting an area identification code to the ticket service center; and
(d) transmitting by the ticket service center correlated ticketing information corresponding to the area identification code via a short message or an e-mail to the portable Internet handheld device.

14. The method as recited in claim 13, wherein the area identification code is a zip code.

15. The method as recited in claim 13, wherein the portable Internet handheld device having a USB interface.

16. The method as recited in claim 13, wherein the correlated ticketing information is displayed on a web page.

17. The method as recited in claim 16, wherein the web page corresponds to a web site having a plurality of random numbers generated by a random number generator.
